(19) United States
(12) Patent Application Publication
(10) Pub. No.: US 2018/0033277 A1
(43) Pub. Date: Feb. 1, 2018

(54) BABYBEEP

(71) Applicant: Sheila A. Entis, Tel Aviv (IL)

(72) Inventor: Sheila A. Entis, Tel Aviv (IL)

(21) Appl. No.: 15/661,020

(22) Filed: Jul. 27, 2017

Related U.S. Application Data
(60) Provisional application No. 62/367,135, filed on Jul. 27, 2016.

(51) Int. Cl. G08B 21/02; B60Q 9/00

(52) U.S. Cl. CPC G08B 21/02; B60Q 9/00

(57) ABSTRACT

A system for generating an alert indicating that a vehicle has not been checked to determine if a child may have been left in the vehicle, the system comprising: at least one alarm system; a controller configured to control the at least one alarm system and be coupled to an in-vehicle communication network of the vehicle to: receive signals transmitted over the network; process the received signals to determine whether within a predetermined time lapse from a time at which after the ignition has been turned from on to off and a driver door of the vehicle opened, whether a compliance action which indicates that the vehicle has been checked to determine if a child is in the vehicle has been performed; and if not, control the at least one alarm system to generate a first alarm.

### RELATED APPLICATIONS

This application claims benefit under 35 U.S.C. 119(e) of U.S. Provisional Applications 62/367,135 filed Jul. 27, 2016 the disclosure of which are incorporated herein by reference.

### TECHNICAL FIELD

Embodiments of the disclosure relate to methods and systems for preventing a child from being forgotten in a vehicle.

### BACKGROUND

Another child was forgotten and left behind in a closed car on a hot summer day by an absent minded driver. The child didn't survive and families were left stained with loss and pain for the remainder of their lives.

### SUMMARY

An aspect of an embodiment of the disclosure relates to providing a method and apparatus for mitigating a probability that an absent minded driver might leave and lock a vehicle forgetting that a child was left behind in the vehicle. In an embodiment, the apparatus, hereinafter also referred to as “BABYBEEP” or BABYBEEP module, comprises a controller coupled to an in-vehicle communication network of the vehicle and comprises, and/or has access to, an alarm system. The controller is configured to receive signals from the in-vehicle communication network to determine if upon the driver exiting or preparing to exit the vehicle, optionally the driver, has performed an action, hereinafter also referred to as a compliance action or BABYBEEP compliance action, which indicates that the vehicle has been checked to determine if a child is in the vehicle.

In an embodiment of the disclosure a BABYBEEP compliance action comprises opening and closing a back door of the vehicle undertaken optionally by the driver, optionally subsequent to opening the driver door and exiting the vehicle, and prior to closing all the vehicle doors and/or locking the vehicle. The BABYBEEP controller is configured to control the alarm system to generate an alarm, also referred to as a BABYBEEP alarm, if the controller has determined that the compliance action was not performed, and to maintain the alarm until the compliance action is performed. Optionally, the BABYBEEP alarm is a crescendoed alarm that increases in intensity with elapsed time from a time, hereinafter also referred to as a trigger time, at which all doors of the vehicle are closed without the occurrence of the compliance action.

In an embodiment, BABYBEEP comprises or has access to a mobile communication interface that the controller is configured to use to access a mobile communication network. If following a predetermined time delay, hereinafter also referred to as a critical time delay, the compliance action has not been performed, the BABYBEEP controller communicates an emergency alarm via the mobile network to a communication device to alert a user of the communication device that a child may have been left in the vehicle and that emergency intervention may be required.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the disclosure are described below with reference to figures attached hereto that are listed following this paragraph. Identical features that appear in more than one FIGURE are generally labeled with a same label in all the FIGURES in which they appear. A label labeling an icon representing a given feature of an embodiment of the disclosure in a FIGURE may be used to reference the given feature. Dimensions of features shown in the figures are chosen for convenience and clarity of presentation and are not necessarily shown to scale.

FIG. 1 schematically shows a simplified flow diagram of an algorithm by which a BABYBEEP module connected to an in-vehicle communication network generates an alarm, in accordance with an embodiment of the disclosure.

### DETAILED DESCRIPTION

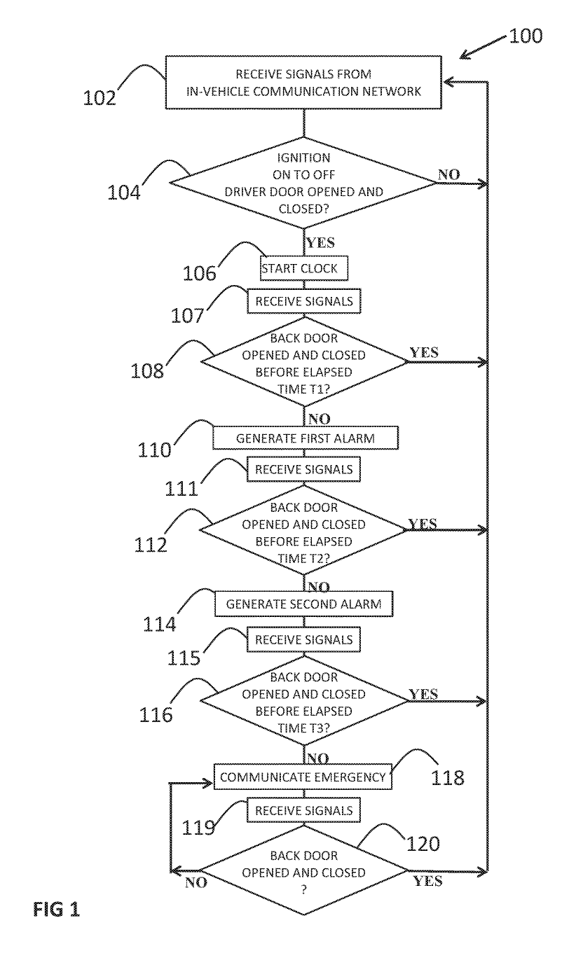

In the detailed description below a procedure by which a BABYBEEP module coupled to an in-vehicle communication network by a wire and/or wireless communication interface operates to generate a BABYBEEP alarm in accordance with an embodiment is discussed with reference to the flow diagram shown in FIG. 1. BABYBEEP may comprise a controller and an alarm system that the controller controls to generate an alarm if the controller determines there is an indication that a person having left the vehicle has not checked to determine if a child is being left in the vehicle.

The in-vehicle communication network may be any of various in-vehicle communication networks known in the art. Popular in-vehicle network communication networks currently available are CAN (control area network), FlexRay, MOST (Media Oriented Systems Transport), Ethernet, and LIN (local interconnect network). The networks define protocols and may define a communication bus and how ECUs (electronic control units), sensors, and actuators, generically referred to as nodes, connected to the communication bus, access and use the bus to transmit signals to each other

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which the embodiment is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. Unless otherwise indicated, the word “or” in the description and claims is considered to be the inclusive “or” rather than the exclusive or, and indicates at least one of, or any combination of more than one of items it conjoins.

A BABYBEEP module in accordance with an embodiment of the disclosure may comprise hardware and/or software components and may be a centralized “monolithic” module, or a distributed module in which components are separate and distributed spatially and/or logically. For example, a BABYBEEP module may be unitary hardware module that is physically coupled to the in-vehicle network or may be a software module comprising executable instructions comprised in at least one electronic control unit (ECU) and/or other node comprised in or connected to the in-vehicle network. To support functionalities that BABYBEEP performs, BABYBEEP may comprise and/or have access to any processing, memory, communication, and/or control circuitry known in the art.

By way of example, in an embodiment. BABYBEEP may comprise any electronic and/or optical processing, memory, communication, and/or control circuitry, to provide and enable functionalities that BABYBEEP may require to support generating a BABYBEEP alarm. BABYBEEP may comprise and/or have access to any one, or any combination of more than one of, a microprocessor, an application specific circuit (ASIC), field programmable array (FPGA), and/or system on a chip (SOC). BABYBEEP may comprise and/or have access to a memory having any electronic and/or optical circuitry suitable for storing data and/or computer executable instructions and may, by way of example, comprise any one or any combination of more than one of a flash memory, random access memory (RAM), read only memory (ROM), and/or erasable programmable read-only memory (EPROM). And BABYBEEP may comprise and/or have access to any suitable wire and/or wireless communication interface to enable BABYBEEP to communicate with the in-vehicle communication network and/or with a communication device outside of the in-vehicle communication network. For example, BABYBEEP may comprise and/or have access to electronic and/or optical circuitry that provides BABYBEEP with at least one of, or any combination of more than one of WiFi, WiFi direct, blue tooth, and/or any of the various radio communication interfaces that enable connection to a mobile communication network.

In an embodiment instructions that may be executed to provide BABYBEEP functionalities may be comprised in a smartphone, and BABYBEEP alarm generation and communication functionalities of BABYBEEP may be supported by processor, memory, and/or communication circuitry comprised in the smartphone that support smartphone functionalities. Instructions that may be executed to provide BABYBEEP functionalities may be downloadable to the smartphone from the Internet.

Flow diagram 100 shows a procedure that a BABYBEEP in accordance with an embodiment of the disclosure may use to generate a BABYPEEP alarm.

In a block 102 BABYBEEP receives signals from an in-vehicle network of a vehicle to which BABYBEEP is connected. In a decision block 104 BABYBEEP processes the received signals to determine if the vehicle ignition has been turned from on to off and a driver door subsequently been opened and then closed. If the ignition has not been turned from on to off and a driver door subsequently opened and closed, BABYBEEP returns to block 102 to receive signals from the in-vehicle network. If on the other hand the ignition has been turned from on to off and the driver door subsequently opened and closed, BABYPEEP optionally proceeds to a block 106 and starts a clock, which may be a counter. In a block 107 BABYBEEP receives signals from the in-vehicle network and in a decision block 108 determines if before a first elapsed clock time T1 a back door of the vehicle has been opened and then closed. If so BABYBEEP returns to block 102 to receive signals from the in-vehicle communication network. If not on the other hand, in a block 110 BABYBEEP generates a first alarm and proceeds to a block 111 to receive additional signals from the in-vehicle network. In a decision block 112 BABYBEEP processes the additional signals to determine if before a second elapsed clock time T2 greater than T1 a back door of the vehicle has been opened and closed. If a back door has been opened and closed before elapse of a time T2, BABYPEEP stops the alarm and returns to block 102 to receive signals from the in-vehicle communication network. If on the other hand a back door has not been opened and closed before elapsed clock time T2, BABYBEEP optionally generates in a block 114 a second alarm, optionally configured to attract more attention than the first alarm. BABYBEEP may then proceed to a block 115 to receive further signals from the in-vehicle network.

In an embodiment, in a decision block 116 BABYBEEP processes the further signals to determine if prior to elapse of an elapsed clock time T3 greater than time T2 a back door of the vehicle has been opened and optionally closed. If yes, BABYBEEP stops the second alarm and returns to block 102 to receive signals from the in-vehicle communication network. If on the other hand following time T3 a back door has not been opened, BABYBEEP transmits emergency alarm messages indicating that the vehicle has not been checked to determine if a child has been left in the vehicle, to at least one, and optionally a plurality of predetermined mobile communication devices, also referred to as emergency communication devices.

An emergency communication device to which BABYBEEP transmits an emergency message may by way of example be any of various communication devices such as a smartphone, legacy mobile phone, laptop, tablet, iPad, or personal digital assistant. Optionally, an emergency communication device to which BABYBEEP transmits an emergency message is a communication device such as a smartphone belonging to a driver of the car. Optionally, an emergency communication device is a device of a parent, or caregiver of a child that may be expected to be in the vehicle.

While and/or subsequent to generating and transmitting emergency alarm messages BABYBEEP may continue to a block 119 to receive further additional signals from the in-vehicle communication network and in a decision block 120 process the further additional signals to determine if the signals indicate that a hack door of the vehicle has been opened and closed. If the door has been opened and closed, BABYBEEP may cease generating alarms and return to block 102 to receive signals from the in-vehicle communication network. If the back door has not been opened and closed BABYBEEP may return to block 118 and continue generating and transmitting emergency alarm messages.

By way of a numerical example, time T1 may be a time period sufficient for a driver having exited a vehicle to remove a child from a back seat of the vehicle. Optionally T1 is equal to or less than about 5 minutes. In an embodiment, T1 is less than or equal to about 10 minutes. T2 may be less than or equal to about 15 minutes and T3 may be less than or equal to about 20 minutes. BABYBEEP first and second alarms may be audio and/or visual alarms and may for example comprise sounding a vehicle horn and/or flashing a vehicle light. Optionally second alarms are configured to be more intense than first alarms. In an embodiment as a delay from a the clock start time of block 106 increases, BABYBEEP may be configured to increase intensity of an alarm that it generates. In an embodiment while transmitting alarm messages BABYBEEP may continue generating second alarms.

There is therefore provided in accordance with an embodiment of the disclosure a system for generating an alert indicating that a vehicle has not been checked to determine if a child may have been left in the vehicle, the system comprising: at least one alarm system; a controller configured to control the at least one alarm system and be coupled to an in-vehicle communication network of the vehicle to: receive signals transmitted over the network; process the received signals to determine whether within a predetermined time lapse from a time at which after the ignition has been turned from on to off and a driver door of the vehicle opened, whether a compliance action which indicates that the vehicle has been checked to determine if a child is in the vehicle has been performed; and if not, control the at least one alarm system to generate a first alarm.

Optionally, the controller is configured so that if the compliance action has not been performed within an additional time lapse, the controller controls an alarm system of the at least one alarm system to generate a second alarm. Optionally, the second alarm is configured to attract more attention than the first alarm.

Additionally or alternatively, the controller may be configured so that if the compliance action has not been performed within yet another additional time lapse, the controller transmits an emergency alarm message indicating that the vehicle has not been checked to determine if a child has been left in the vehicle. Optionally the emergency alarm message is transmitted to at least one mobile communication device via a mobile communication network.

In an embodiment of the disclosure, the compliance action comprises opening a back door of the vehicle.

In an embodiment of the disclosure, an alarm system of the at least one alarm system is comprised in the vehicle. In an embodiment of the disclosure, an alarm system of the at least one alarm system is comprised in a mobile communication device. Optionally, the controller is comprised in the mobile communication device.

In an embodiment of the disclosure, the controller is comprised in the vehicle. In an embodiment of the disclosure, the controller is comprised in a mobile communication device.

There is further provided in accordance with an embodiment of the disclosure, a method for generating an alert indicating that a vehicle has not been checked to determine if a child may have been left in the vehicle, the method comprising: determining if a compliance action which indicates that the vehicle has been checked to determine if a child is in the vehicle has been performed within a predetermined time lapse from a time at which the ignition of the vehicle has been turned from on to off and a driver door of the vehicle opened; and if not, generating a first alarm.

Optionally the method comprises generating a second alarm if the compliance action has not been performed within an additional time lapse. Optionally, the second alarm is configured to attract more attention than the first alarm.

In an embodiment the method comprises transmitting an emergency alarm message indicating that the vehicle has not been checked to determine if a child has been left in the vehicle if the compliance action has not been performed within yet another additional time lapse. Optionally transmitting the emergency alarm message comprises transmitting the emergency alarm message to at least one mobile communication device via a mobile communication network.

In an embodiment the compliance action comprises opening a back door of the vehicle.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the disclosure is limited only by the claims.

1. A system for generating an alert indicating that a vehicle has not been checked to determine if a child may have been left in the vehicle, the system comprising:
at least one alarm system;
a controller configured to control the at least one alarm system and be coupled to an in-vehicle communication network of the vehicle to:
receive signals transmitted over the network;
process the received signals to determine whether within a predetermined time lapse from a time at which after the ignition has been turned from on to off and a driver door of the vehicle opened, whether a compliance action which indicates that the vehicle has been checked to determine if a child is in the vehicle has been performed; and
if not, control the at least one alarm system to generate a first alarm.

2. The system according to claim 1 wherein the controller is configured so that if the compliance action has not been performed within an additional time lapse, the controller controls an alarm system of the at least one alarm system to generate a second alarm.

3. The system according to claim 2 wherein the second alarm is configured to ore attention than the first alarm.

4. The system according to claim 2 wherein the controller is configured so that if the compliance action has not been performed within yet another additional time lapse, the controller transmits an emergency alarm message indicating that the vehicle has not been checked to determine if a child has been left in the vehicle.

5. The system according to claim 4 wherein the emergency alarm message is transmitted to at least one mobile communication device via a mobile communication network.

6. The system according to claim 1 wherein the compliance action comprises opening a back door of the vehicle.

7. The system according to claim 1 wherein an alarm system of the at least one alarm system is comprised in the vehicle.

8. The system according to claim 1 wherein an alarm system of the at least one alarm system is comprised in a mobile communication device.

9. The system according to claim 8 wherein the controller is comprised in the mobile communication device.

10. The system according to claim 1 wherein the controller is comprised in the vehicle.

11. The system according to claim 1 wherein the controller is comprised in a mobile communication device.

12. A method for generating an alert indicating that a vehicle has not been checked to determine if a child may have been left in the vehicle, the method comprising:
determining if a compliance action which indicates that the vehicle has been checked to determine if a child is in the vehicle has been performed within a predetermined time lapse from a time at which the ignition of the vehicle has been turned from on to off and a driver door of the vehicle opened; and
if not, generating a first alarm.

13. The method according to claim 12 and comprising generating a second alarm if the compliance action has not been performed within an additional time lapse.

14. The method according to claim 13 wherein the second alarm is configured to attract more attention than the first alarm.

15. The method according to claim 12 and comprising transmitting an emergency alarm message indicating that the vehicle has not been checked to determine if a child has been left in the vehicle if the compliance action has not been performed within yet another additional time lapse.

16. The method according to claim 15 and comprising transmitting the emergency alarm message to at least one mobile communication device via a mobile communication network.

17. The method according to claim 12 wherein the compliance action comprises opening a back door of the vehicle.
